(19) United States
(12) Patent Application Publication
(10) Pub. No.: US 2010/0199884 A1
(43) Pub. Date: Aug. 12, 2010

(54) Composition for Producing Starch Foam Resistant to Moisture and Freeze-Thaw Cycles

(76) Inventors: Claudio Rocha Bastos, Rio de Janeiro (BR); Patricia Ponce, Sao Paulo (BR); Laura Goncalves Carr, Sao Paulo (BR); Duclerc Parra Fernandes, Sao Caetano do Sul (BR); Lugão Ademar Benevolo, Sao Paulo (BR)

Correspondence Address: ARENT FOX LLP, 1050 CONNECTICUT AVENUE, N.W., SUITE 400, WASHINGTON, DC, 20036, US

(21) Appl. No.: 11/922,326

(22) PCT Filed: Jun. 16, 2006
(86) PCT No.: PCT/BR2006/000115

§ 371 Date: Nov. 16, 2009

(30) Foreign Application Priority Data
Jun. 16, 2005 (BR) PI 0502338-6

(51) Int. Cl. C08J 9/00

(52) U.S. Cl. 106/122

(57) ABSTRACT

Plastic materials for packaging have increased dramatically in the last two decades, replacing more traditional materials such as paper, glass and metals. Most plastics are made almost entirely from chemicals derived from crude oil that may require hundreds of years to degrade and can kill wildlife if ingested. Disposal of used packaging products has been an ecological problem due to their non-degrability. Agricultural-based materials are beginning to emerge as promising substitutes for petroleum-based plastics. These so-called bio-based materials, such as starch and cellulose, have the advantage of being derived from a renewable source and be biodegradable into a useful compost.

The present invention provides starch foam, as biodegradable packaging material, comprising an expanded starch and water batter by thermo process. Starch foam has low-density and closed cell structure and is mechanical resistant in different temperatures, mainly lower and freezing temperatures.

The essential feature of this invention is its ability to produce starch foam resistant to freeze-thaw cycles. This ability is due to the higher batter viscosity that produces foams with resistant internal structure.

Additive compounds may also be added to the formulation (plasticizers, thickening agents, organic and inorganic fillers, pigments and preservatives) to improve starch foam mechanical properties in freeze-thaw cycles.

Starch foam can be coated with hydrophobic film to improve the moisture resistance.

Plastic materials for packaging have increased dramatically in the last two decades, replacing more traditional materials such as paper, glass and metals. Most plastics are made almost entirely from chemicals derived from crude oil that may require hundreds of years to degrade and can kill wildlife if ingested.

Disposal of used packaging products has been an ecological problem due to their non-degrability. When discarded, packaging can become the most obvious source of litter generated by the public. This has caused increasing environmental concerns because approximately 85% of municipal waste ends up in landfill sites.

The use of biodegradable packaging materials has greater potential in countries where landfills are the main waste management tool.

Tice growing interest in the environmental impact of discarded plastics has directed research on the development of materials that degrade more rapidly in the environment. Agricultural-based materials are beginning to emerge as promising substitutes for petroleum-based plastics. These so-called bio-based materials, such as starch and cellulose, have the advantage of being derived from a renewable source and be biodegradable into a useful compost.

The term “biodegradable” materials describes those materials degraded by the enzymatic action of living organisms, such as bacteria, yeasts, fungi and the ultimate end-products of the degradation process, these being CO₂, H₂O, and biomass under aerobic conditions and hydrocarbons, methane, and biomass under anaerobic conditions.

Starch is an alternative raw material for food packaging because it is a biodegradable polymer that is inexpensive, widely available and derived from a renewable source. Starch is a polysaccharide obtained in granular form from corn, cereal grain, rice, cassava and potatoes, capable of forming foam by a process consisting of swelling, gelatinization and network building.

The U.S. Pat. 6,146,573, describes a process for preparation of starch foam by a thermo pressing process in a two-part mold. Starch foams are coated with hidrofobic films to improve its moisture resistance. These foams can be made with corn, potato or modified starch, or a mixture thereof, adding polyvinyl alcohol, release agent and water at a proportion of 100% to 360% by solid weight.

The U.S. Pat. No. 4,863,655 describes a method for preparing an expanded biodegradable, low-density packaging material comprising extruding starch containing at least 45% by weight amylose content of 21% or less by weight and at temperature of from about 151° C. to 250° C.

The EP Patent 0.712.883 describes a biodegradable product by extrusion process, with good properties such as strength, flexibility and resilience. It is necessary to use starch with a specific size to produce this biodegradable product.

The U.S. Pat. No. 5,545,450 relates to compositions, methods and systems for manufacturing articles, particularly containers and packaging materials, having a highly inorganically filled matrix and a water dispersible organic polymer selected from the group consisting of polysaccharides and proteins.

According U.S. Pat. No. 5,756,194, starch based products can be coated with biodegradable polyesters, such as PHBV, PLA and PCL, using different natural shellac that promotes the polyester-starch adhesiveness.

In Patent W 090/01043, Tomka et al. used DMSO to improve the adhesiveness of the starch and polymer hydrophobic bases. The polymers used are PHBV, PLA, and PCL.

To improve the moisture resistance, the starch can be chemically modified, according to specifications the U.S. Pat. No. 5,869,647, resulting in a hydrophobic product.

However, these materials are not resistant to freeze-thaw cycles. This is an important characteristic for packaging, mainly in transportation and storage situations.

### SUMMARY OF THE INVENTION

The present invention provides starch foam, as biodegradable packaging material, comprising an expanded starch and water batter by thermo process. Starch foam has low-density and closed cell structure and is mechanical resistant in different temperatures, mainly lower and freeing temperatures.

Additive compounds may also be added to the formulation (plasticizers, thickening agents, organic and inorganic fillers, pigments and preservatives) to improve starch foam mechanical properties in freeze-thaw cycles.

Starch foam can be coated with hydrophobic film to improve the moisture resistance, i.e. water, oil and fruits juice.

The advantages of using starch foam as packaging are:

1) Only non toxic substances are necessary to produce starch foam;

2) Starch foam production requires lower costs;

3) Starch foam degrades in only 20 days in water or steam without leaving residue in the environment, white petroleum-based foam may require hundreds of years to degrade.

4) Starch is from renewable source.

### DETAILED DESCRIPTION OF THE INVENTION

The present invention provides a starch foam resistant to freeze-thaw cycles. Starch foam is a biodegradable packaging and can be used for dry or wet products, in different temperatures, mainly lower and freeze temperatures. Starch foam has low-density with an internal closed cell structure.

According the present invention, starch foam is prepared with a starch and water batter, processed in heated conditions. Additive compounds may also be added to the batter (plasticizers, thickening agents; organic and inorganic fillers, pigments and preservatives) to improve the mechanical properties. The batter moisture content is approximately 25% to 99% by total solid weight, (the following phrase, depending equipment used. Additives can be added concentrated or diluted in water for approximately 0.0001% to 50%. Organic or inorganic filler aggregate has a concentration in a range of approximately 0.1% to 80% by total weight. Pigments, luminescence agent, and preservative aggregate have a concentration in a range of approximately 0.0001% to approximately 10% by total weight.

Starch foam can be produced by thermo pressing, extruder, thermo expansion, and injection processes.

To improve the moisture resistance, starch foam can be coated with a hydrophobic film after expanded or a hydrophobic polymer can be processed with starch and water batter. The foams can be coated by immersion, lamination and pulverization process.

The essential feature of this invention is its ability to produce starch foam resistant to freeze-thaw cycles. This ability is due to the higher batter viscosity that produces foams with resistant internal structure. Additive such as thickening agents (i.e. pre gelatinized starch) or organic and inorganic filler can be added to increase the batter viscosity. The additives may also improve the coated and starch adhesion.

Resistance to freeze-thaw cycles is an important characteristic of packaging, mainly in transportation and storage situations. Starch foam can comprise the following container shapes: a box, a fork, a tube, a cup, clamshell, an egg carton, a plate, a tray and protective packaging.

### EXAMPLES

### Example 1

Trays produced from foamed starch were made from high and low viscosity compositions and subjected to compression tests. The trays from the high viscosity composition showed improved resistance to compression as compared with the trays from low viscosity composition.

TABLE 1

| Trays of Starch Foams | Force (N) |
|---|---|
| High viscosity | 29.6 |
| | 26.9 |
| Low viscosity | 21.1 |
| | 17.3 |

### Example 2

A tray of starch was made from low viscosity composition without addition of mineral fillers and was coated by immersion in solution of biodegradable polyester followed by drying in air. The polyester film lost its adhesion to the starch surface just after the drying process by film contraction. In another experiment, the foams were produced from high viscosity composition with addition of inorganic fillers and coated as described above. It was observed that the coated polyester had a perfect adhesion for the starch surface. Table 2 shows the results of the assays of delamination, i.e., the measurement of the force necessary to tear the film from the starch surface. The measurement was performed by a dynamometer (load cell; 5N; speed of 50 mm/min).

TABLE 2

| | Delamination force |
|---|---|
| | coating/starch surface |
| Starch foams | (gf/pol) |
| High viscosity composition with mineral filler | 99.0 |
| Low viscosity composition without mineral filler | 74.2 |

### Example 3

A tray of starch was made from low viscosity composition without addition of mineral fillers and was coated by immersion in solution of biodegradable polyester followed by drying in air. This tray was placed in a freezer for one month. Afterwards, the tray was exposed to the environment, where it showed itself soft and vulnerable to compression. It was recorded that the open cell density of the foam was relatively low, explaining its deformation during storage in the freezer. The distortion of the tray substrate jeopardized the quality of the coating, allowing the diffusion of humidity and/or fat to the starch.

TABLE 3

| Viscosity level of starch composition | Force (N) | Force (N) |
|---|---|---|
| for production of trays | before freezing | after freezing |
| High viscosity | 29.6 | 29.1 |
| | 26.9 | 26.7 |
| Low viscosity | 17.3 | 9.9 |
| | 21.1 | 11.9 |

### Example 4

Starch foams were produced based on compositions of different viscosities. They were coated with biodegradable polyester films and frozen for 24 hours at −18° C. After this period, the mechanical properties assays (stress and strain at break) were conducted for all foams. The starch foams from high viscosity compositions were more resistant to strain and stress than foams from low viscosity compositions. The starch foams from high viscosity showed the same level of properties of the foams coated and stored at room temperature.

TABLE 4

| | Stress at | Strain at |
|---|---|---|
| Samples of starch foam | break (MPA) | break (%) |
| Low viscosity (stored at 24° C.) | 1.97 | 11.35 |
| Low viscosity (stored at −18° C.) | 1.67 | 10.20 |
| High viscosity (stored at 24° C.) | 3.03 | 9.72 |
| High viscosity (stored at −18° C.) | 2.99 | 8.10 |

1. A formulation for producing starch foams resistant to freeze-thaw cycles, consisting of a starch and water batter processed in a hot process.

2. A starch foam according to claim 1, wherein the foams are compression and deformation resistant at −45° C. to 0° C.

3. A starch foam according to claim 1, wherein the foams are compression and deformation resistant at 1° C. to 10° C.

4. A starch foam according to claim 1, wherein the foams are compression and deformation resistant at 11° C. to 35° C.

5. A starch foam according to claim 1, wherein the foams resist for 1 to 15 freeze-thaw cycles.

6. A starch foam according to claim 1, wherein the total moisture content is comprised of approximately 25% to 50% by weight of solid components.

7. A starch foam according to claim 1, wherein the total moisture content is comprised of approximately 51% to 75% by weight of solid components.

8. A starch foam according to claim 1, wherein the total moisture content is comprised of approximately 76% to 99% by weight of solid components.

9. A starch foam according to claim 1, which further comprises adding inorganic filler to the batter composition.

10. A starch foam according to claim 1, which further comprises adding organic filler to the batter composition.

11. A starch foam according to claim 1, which further comprises adding additives, such as thickening agents and plasticizers to the batter composition.

12. A starch foam according to claim 1, which further comprises adding pigments to the batter composition.

13. A starch foam according to claim 1, wherein the inorganic filler aggregate has a concentration in a range of approximately 0.0001% to about 80% by weight of total solids.

14. A starch foam according to claim 1, wherein the inorganic filler aggregate in the composition of the foam is kaolin.

15. A starch foam according to claim 1, wherein the inorganic filler aggregate in the composition of the foam is mullite.

16. A starch foam according to claim 1, wherein the inorganic filler aggregate in the composition of the foam is talcum.

17. A starch foam according to claim 1, wherein the inorganic filler aggregate in the composition of the foam is calcium carbonate.

18. A starch foam according to claim 1, wherein the inorganic filler aggregate in the composition of the foam is bentonite.

19. A starch foam according to claim 1, wherein the inorganic filler aggregate in the composition of the foam is mica.

20. A starch foam according to claim 1, wherein the inorganic filler aggregate in the composition of the foam is illite.

21-122. (canceled)
